(19) United States
(12) Patent Application Publication
(10) Pub. No.: US 2010/0210216 A1
(43) Pub. Date: Aug. 19, 2010

(54) Detecting Movement of Housing Sections in a Portable Electronic Device

(75) Inventor: Johan Olof Westlund, Malmo (SE)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 12/371,942

(22) Filed: Feb. 17, 2009

(51) Int. Cl. H04M 1/00; H04B 7/00

(52) U.S. Cl. 455/66.1

(57) ABSTRACT

In a wireless communication device having two housing sections that move relative to one another between open and closed positions, relative movement between the housing sections is detected using a pair of accelerometers. One accelerometer is disposed on or in a first housing section and one accelerometer is disposed on or in a second housing section. A control unit in the wireless communication device detects the opening and closing of the housing sections by detecting differences between the acceleration of the housing sections.

### BACKGROUND

The present invention relates generally to handheld and portable electronic devices having two or more housing sections that move between open and closed positions and, more particularly, to a method and apparatus for detecting relative movement of the housing sections.

Many portable electronic devices, such as cellular phones, smart phones, and personal digital assistants (PDAs) have multi-part housings with two or more housing sections that pivot, rotate, or slide relative to one another between open and closed positions. For example, clamshell-type mobile phones (also known as a flip phones) typically comprise two housing section pivotally connected along one side by a hinge. One section serves as a cover or flip and pivots between open and closed positions to cover the display and/or keypad of the phone. Sliding designs (referred to herein as sliders) are known in which two or more housing sections slide relative to one another. There are also jackknife designs where two or more sections rotate relative to one another like a jackknife.

Cell phones and other electronic devices with two-part housings typically use magnetic resonance sensors or Hall effect sensors to detect movement of the housings. Magnetic resonance sensors and Hall effect sensors are two types of sensors that vary output voltage in response to changes in a magnetic field. In wireless communication devices, the magnetic resonance sensor or Hall effect sensor is disposed in one housing section and a small magnet is disposed in the other housing. When the housing sections are moved between open and closed position, the magnetic resonance sensor or Hall effect sensor senses the change in the magnetic field.

Magnetic resonance sensors and Hall effect sensors may fail to operate properly if the magnetic field produced by the magnet is disturbed by metallic objects or other magnets in proximity to the wireless communication device. For example, the wireless communication device may be placed in a handbag with a magnetic closure that can disturb the magnetic field. Also, metallic objects place in close proximity to the wireless communication device can disturb the magnetic field. Accordingly, there is a need for new ways to detect opening and closing movements to replace magnetic responses sensors or Hall effect sensors.

### SUMMARY

In a wireless communication device having two housing sections that move relative to one another between open and closed positions, relative movement between the housing sections is detected by detecting a difference in the acceleration of the first and second housing sections. One accelerometer is disposed on a first housing section and one accelerometer is disposed on a second housing section. When a user opens or closes the housing sections, there is a distinct difference in the acceleration between the first and second housing sections. On the other hand, when the phone is dropped or moved bodily, the acceleration for the housing sections will be the same. A control unit in the wireless communication device receives input signals indicative of the accelerations of the first and second housing sections and detects the opening and closing of the housing sections by determining the difference between the accelerations of the housing sections.

Exemplary embodiments of the present invention comprise a wireless communication device. In one embodiment, the wireless communication device comprises a housing including first and second housing sections; a hinge to movably connect the first and second housing sections such that the first and second housing sections move relative to each other between an open position and a closed position; first and second accelerometers disposed in said first and second housing sections, respectively; and a control unit configured to receive input signals from said first and second accelerometers indicative of the accelerations of said first and second housing section, respectively, and to detect relative movement of said first and second housing sections based a difference in said accelerations of said first and second housing sections.

In some embodiments of the wireless communication device, the hinge slidably connects the first and second housing sections such that the first and second housing sections slide relative to each other between the open and closed positions generally parallel to a separation plane of said first and second housing sections.

In some embodiments of the wireless communication device, the hinge pivotally connects the first and second housing sections such that the first and second housing sections pivot relative to each other between the open and closed positions about an axis that is generally parallel to a separation plane of said first and second housing sections.

In some embodiments of the wireless communication device, the hinge pivotally connects the first and second housing sections such that the first and second housing sections rotate relative to each other between the open and closed positions about an axis that is generally perpendicular to a separation plane of said first and second housing sections.

In some embodiments of the wireless communication device, the control unit detects relative movement of said first and second housing sections by comparing said difference in said accelerations of said first and second housing sections to a threshold.

In some embodiments of the wireless communication device, the control unit is configured to trigger a predetermined function responsive to detection of relative movement between said first and second housing sections.

Other embodiments of the present invention comprise methods detecting relative movement between first and second housing sections of a wireless communication device. In one exemplary embodiment, the method comprises receiving first and second input signals indicative of the accelerations of said first and second housing sections respectively; and detecting relative movement of said first and second housing sections based on a difference in the accelerations of said first and second housing sections.

In some embodiments of the method, the first and second housing sections slide relative to one another in a plane generally parallel to a separation plane of said first and second housing sections, wherein detecting relative movement of said first and second housing sections comprises detecting relative sliding movement of said first and second housing sections.

In some embodiments of the method, the first and second housing sections pivot relative to one another about an axis that is generally parallel to a separation plane of said first and second housing sections, wherein detecting relative movement of said first and second housing sections comprises detecting relative pivotal movement of said first and second housing sections about said axis.

In some embodiments of the method, the first and second housing sections rotate relative to one another about an axis that is generally perpendicular to a separation plane of said first and second housing sections, wherein detecting relative movement of said first and second housing sections comprises detecting relative rotational movement of said first and second housing sections about said axis.

In some embodiments of the method, detecting relative movement of said first and second housing sections based on a difference in the accelerations of said first and second housing sections comprises comparing said difference in said accelerations of said first and second housing sections to a threshold.

Some embodiments of the method further comprises triggering a predetermined function of said wireless communication device responsive to the detection of relative movement between said first and second housing sections.

### BRIEF DESCRIPTION OF THE DRAWINGS

FIG. 1 is a functional block diagram of a wireless communication device according to one exemplary embodiment.

FIGS. 2A and 2B illustrate an exemplary wireless communication device (e.g., flip phone) with two housing sections that pivot about an axis parallel with the separation plane between the two housing sections.

FIGS. 3A and 3B illustrate and exemplary wireless communication device (e.g., slide phone) with two housing sections that slide relative to one another in a direction parallel to the separation plane between the two housing sections.

FIGS. 4A and 4B illustrate and exemplary wireless communication device (e.g., jackknife phone) with two housing sections that rotate relative to one another about an axis perpendicular to the separation plane between the two housing sections.

FIGS. 5A and 5B illustrate one possible placement of accelerometers in a flip-type wireless communication device.

FIGS. 6A and 6B illustrates one possible placement of accelerometers in a slide-type wireless communication device.

FIGS. 7A and 7B illustrates one possible placement of accelerometers in a jackknife-type wireless communication device.

FIG. 8 illustrates an exemplary method implemented in a wireless communication device for detecting movement of the housing sections.

### DETAILED DESCRIPTION

Referring now to the drawings, the present invention will be described in the context of a wireless communication device indicated generally by the numeral 100. The wireless communication device 100 may comprise, for example, a cellular telephone, personal digital assistant (PDA), smart phone, video/audio players, navigation devices, gaming devices, or laptop computer. Those skilled in the art will appreciate, however, that the present invention may be used in other portable electronic devices, such as video and audio players, navigation devices, and gaming devices.

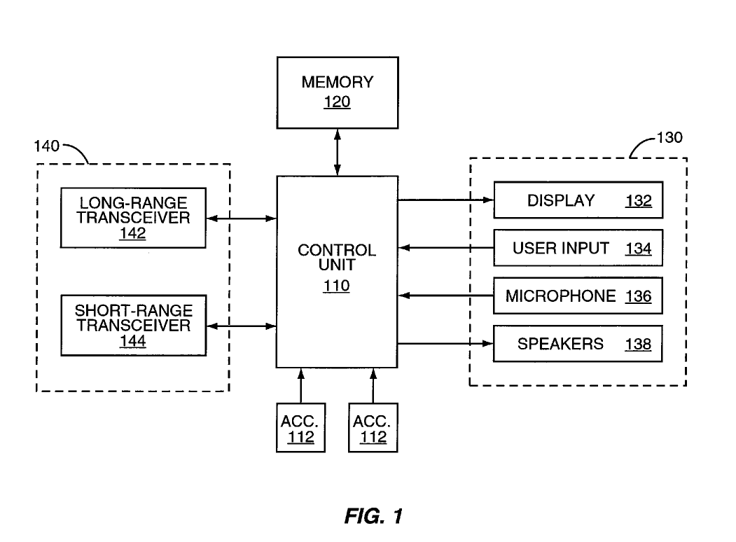

FIG. 1 illustrates in block diagram form the main functional elements of wireless communication device 100 according to one embodiment. The wireless communication device 100 includes control unit 110, memory 120, user interface 130, and communication circuits 140. Control unit 110 may comprise one or more processors, microcontrollers, hardware, or a combination thereof that control the overall operation of the wireless communication device 100 according to programs and applications stored in memory 120. Memory 120 stores program instructions and data needed for operation and may comprise one or more memory devices, including random access memory for temporary storage and read only memory for permanent storage.

The user interface 130 comprises one or more displays 132 and one or more input devices 134 to enable the user to interact with and/or control the wireless communication device 100. The input devices 134 may include, for example, a keypad, joystick, function keys, touch pad, dials, or any other common type of computer input device. In some embodiments, the display 132 may comprise a touch screen display that also functions as a user input device 134. The user interface 130 also includes a microphone 136 and one or more speakers 138. Microphone 136 converts acoustic signals to electrical audio signals for input to the control unit 110. Speaker 138 converts electrical audio signals output by the control unit 110 into acoustic signals that can be heard by the user.

Communication circuits 140 enable voice and/or data communication with remote devices. Communication circuits 140 may, for example, comprise a long-range transceiver 142 and a short-range transceiver 144. The long-range transceiver 142 may comprise a standard cellular transceiver, such as a Wideband Code Division Multiple Access (WCDMA) transceiver, Long Term Evolution (LTE) transceiver, or Worldwide Interoperability for Microwave Access (WiMAX) transceiver. The short-range transceiver may comprise a wireless local area network (WLAN) interface, such as a BLUETOOTH or WIFI transceiver. Communication circuits 140 based on other standards, now known, or later developed, could also be used in the present invention.

The wireless communication device 100 also comprises two or more accelerometers 112. Accelerometers 112 are provided to detect non-gravitational acceleration of the wireless communication device 100. Accelerometers 112 are used in wireless communication devices 100 for a variety of purposes. For example, accelerometers 112 can be used as user interface controls for gaming applications and other user applications. Accelerometers 112 may also be used for image stabilization if the wireless communication device 100 is equipped with a camera (not shown). In the present invention, the accelerometers 112 are also used, in addition to other purposes, to detect relative movement between two housing sections of the wireless communication device 100 as described in greater detail below.

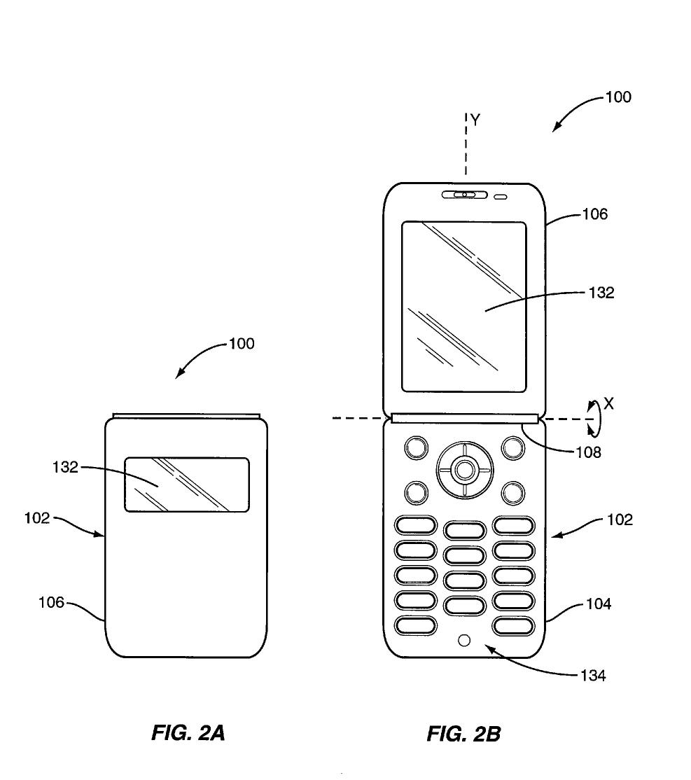

FIGS. 2A and 2B show one exemplary embodiment of the wireless communication device 100 having a housing 102 comprising two housing sections 104, 106 that move relative to one another. For convenience, housing section 104 is referred to herein as the bottom section, and housing section 106 is referred to as the top section. The bottom and top housing sections 104, 106 of the housing 102 are pivotally connected by a hinge 108 so that the two housing sections 104, 106 pivot about an axis X between open and closed positions. The axis X is disposed in a plane that is generally parallel with the separation plane between the housing sections 104, 106. An exemplary wireless communication device 100 configured in this manner is generally known as a flip phone. While the illustrated embodiments have only two housing sections, 104, 106, the housing 102 in some embodiments of the invention could have more than two housing sections.

FIG. 2A illustrates the flip phone 100 in a closed position. In this position, the top section 106 of the housing 102 is folded against the bottom section 104 so that only an external display 132 is visible. FIG. 2B shows the flip phone 100 in an open position with the top section 106 pivoted upward and away from the bottom section 104. In this position, a user input device (e.g., keyboard) 134 and internal display 132 are visible to the user.

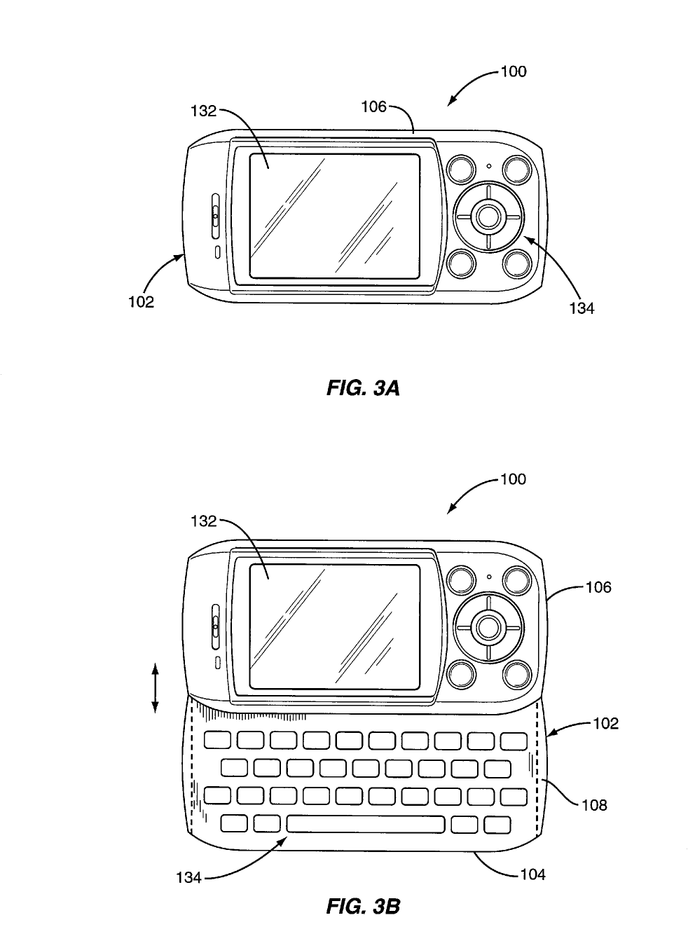

FIGS. 3A and 3B illustrate an alternate embodiment of the wireless communication device 100 in which the two housing sections 104, 106 slide relative to one another between open and closed positions. In this embodiment, the bottom section 104 and top section 106 of the housing 102 are movably connected by a sliding hinge 108. The top section 106 includes a display 132 that is visible in both open and closed positions. The bottom section 104 includes a user input device (e.g., QWERTY keyboard) 134 that is covered in the closed position and accessible in the open position.

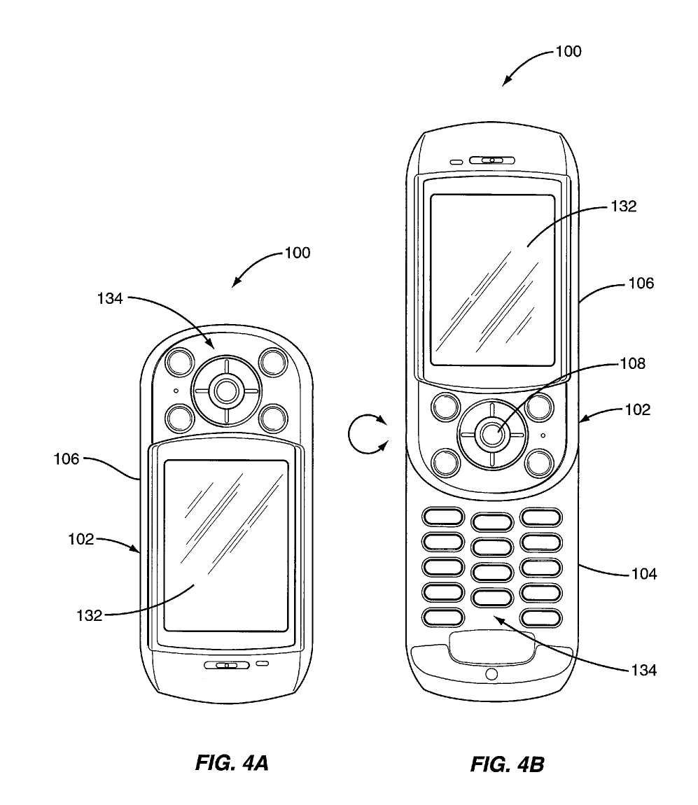

FIGS. 4A and 4B illustrate another embodiment of the wireless communication device 100 having two housing sections 104, 106 that rotate relative to one another between open and closed positions. An exemplary wireless communication device 100 configured in this manner is known as a jackknife phone. In a jackknife phone 100, the housing sections 104, 106 are rotatably connected by a hinge 108 so as to rotate between open and closed positions about an axis that extends perpendicular to the separation plane between the first and second housing sections 104, 106. The top section 106 includes a display 132 that is visible in both the open and closed positions. The bottom section 104 includes a user input device (e.g., keypad) 134 that is covered in the closed position and is accessible in the open position.

In each of the embodiments shown in FIGS. 2-4, the wireless communication device 100 may be configured to perform a predetermined action responsive to movement of the housing sections 104, 106 between the open and closed positions. For example, the wireless communication device 100 may be programmed to answer an incoming call when the housing sections 104, 106 are opened, and to terminate a call when the housing sections 104, 106 are closed.

In the past, movement of the housing sections 104, 106 has been detected by the use of magnetic resonance sensors or Hall effect sensors. Magnetic resonance sensors and Hall effect sensors are two types of sensors that vary output voltage in response to changes in a magnetic field. In wireless communication devices 100, the magnetic resonance sensor or Hall effect sensor is disposed in one housing section 104, 106 and a small magnet is disposed in the other housing section 104, 106. When the housing sections 104, 106 are moved between open and closed position, the magnetic resonance sensor or Hall effect sensor senses the change in the magnetic field. Magnetic resonance sensors and Hall effect sensors may fail to operate properly if the magnetic field produced by the magnet is disturbed by metallic objects or other magnets in proximity to the wireless communication device 100.

According to the present invention, the movement of the housing sections 104, 106 is detected through the use of accelerometers 112, which are already present in many wireless communication devices 100 for other purposes. More particularly, a first accelerometer 112 may be disposed in the bottom section 104, and a second accelerometer 112 may be disposed in the top section 106 of the housing 102. Thus, there are two separate accelerometers 112 in the two housing sections 104, 106. When the wireless communication device 100 is opened or closed by the user, there will be a distinct difference in acceleration between the housing sections 104, 106. On the other hand, when the wireless communication device 100 is dropped, the acceleration for the housing sections 104, 106 will be the same. Thus, the control unit 110 in the wireless communication device 100 detects the opening and closing of the housing sections 104, 106 by detecting differences between the acceleration of the housing sections 104, 106.

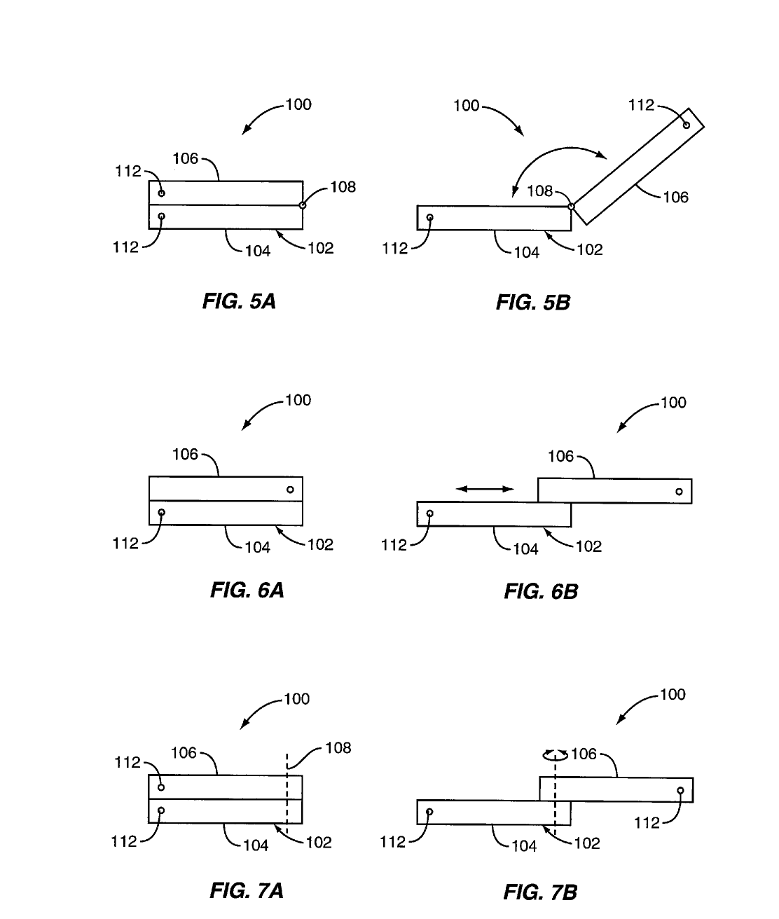

FIGS. 5A and 5B illustrate one recommended placement of the accelerometers 112 in a flip-type wireless communication device 100. In this embodiment, the accelerometers 112 are placed at the ends of the housing sections 104, 106, that is, farthest from the hinge 108.

FIGS. 6A and 6B show one recommended placement for the accelerometers 112 in a slide-type wireless communication device 100. In this embodiment, the accelerometers 112 are disposed at opposing ends of the respective housing sections 104, 106 to maximize the spacing between the accelerometers 112.

FIGS. 7A and 7B illustrate one recommended placement for the accelerometers 112 in a jackknife type wireless communication device 100. The placement of the accelerometers 112 is similar to the flip-type wireless communication device 100. More particularly, the accelerometers 112 are placed at the ends of the housing section 104, 106 that are farthest from the hinge 108.

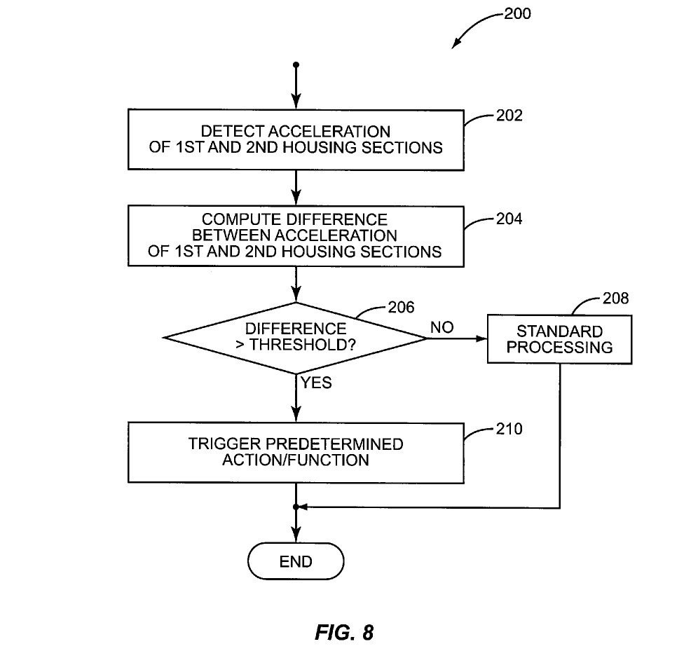

FIG. 8 is a flow chart illustrating the process 200 of detecting movement between the housing sections 104, 106. Accelerometers 112 detect acceleration of the first and second housing sections 104, 106 and provide input signals indicative of the acceleration to the control unit 110 (block 202). The control unit 110 computes a difference between the acceleration of the first and section housing sections (block 204). The difference may be expressed as a vector quantity having a magnitude and direction. The control unit 110 then compares the magnitude of the difference to a predetermined threshold (block 206). In some embodiments, the threshold may be a user programmable setting. If the difference does not exceed the threshold, indicating that the user has not opened or closed the housing sections 104, 106, standard processing is performed to determine what action, if any, is to be taken (block 208). As noted above, the accelerometers 112 may serve as a user input device for a gaming application or other application. Returning to block 206, if the magnitude of the difference exceeds the threshold, indicating that the user has opened or closed the housing sections 104, 106, the control unit 110 triggers a predetermined function or action responsive to the movement of the housing sections 104, 106 (block 210). The control unit 110 can differentiate between an opening movement and a closing movement based on the direction of the different vector. As an example, the control unit 110 may answer an incoming call if the housing sections 104, 106 are opened, or may terminate an active call if the housing sections 104, 106 are closed. Of course, other actions could also be taken responsive to the opening or closing of the housing sections 104, 106 depending on the current mode of the wireless communication device 100.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A wireless communication device comprising:
a housing including first and second housing sections;
a hinge to movably connect the first and second housing sections such that the first and second housing sections move relative to each other between an open position and a closed position;
first and second accelerometers disposed in said first and second housing sections, respectively; and
a control unit configured to receive input signals from said first and second accelerometers indicative of the accelerations of said first and second housing section, respectively, and to detect relative movement of said first and second housing sections based a difference in said accelerations of said first and second housing sections.

2. The device of claim 1 wherein the hinge slidably connects the first and second housing sections such that the first and second housing sections slide relative to each other between the open and closed positions generally parallel to a separation plane of said first and second housing sections.

3. The device of claim 1 wherein the hinge pivotally connects the first and second housing sections such that the first and second housing sections pivot relative to each other between the open and closed positions about an axis that is generally parallel to a separation plane of said first and second housing sections.

4. The device of claim 1 wherein the hinge pivotally connects the first and second housing sections such that the first and second housing sections rotate relative to each other between the open and closed positions about an axis that is generally perpendicular to a separation plane of said first and second housing sections.

5. The wireless communication device of claim 1 wherein the control unit detects relative movement of said first and second housing sections by comparing said difference in said accelerations of said first and second housing sections to a threshold.

6. The device of claim 1 wherein the control unit is configured to trigger a predetermined function responsive to detection of relative movement between said first and second housing sections.

7. A method of detecting relative movement between first and second housing sections of a wireless communication device, said method comprising:
receiving first and second input signals indicative of the accelerations of said first and second housing sections respectively; and
detecting relative movement of said first and second housing sections based on a difference in the accelerations of said first and second housing sections.

8. The method of claim 7 wherein the first and second housing sections slide relative to one another in a plane generally parallel to a separation plane of said first and second housing sections, and wherein detecting relative movement of said first and second housing sections comprises detecting relative sliding movement of said first and second housing sections.

9. The method of claim 7 wherein the first and second housing sections pivot relative to one another about an axis that is generally parallel to a separation plane of said first and second housing sections, and wherein detecting relative movement of said first and second housing sections comprises detecting relative pivotal movement of said first and second housing sections about said axis.

10. The method of claim 7 wherein the first and second housing sections rotate relative to one another about an axis that is generally perpendicular to a separation plane of said first and second housing sections, and wherein detecting relative movement of said first and second housing sections comprises detecting relative rotational movement of said first and second housing sections about said axis.

11. The method of claim 7 wherein detecting relative movement of said first and second housing sections based on a difference in the accelerations of said first and second housing sections comprises comparing said difference in said accelerations of said first and second housing sections to a threshold.

12. The method of claim 7 further comprising triggering a predetermined function of said wireless communication device responsive to the detection of relative movement between said first and second housing sections.
